(19) United States
(12) Patent Application Publication
(10) Pub. No.: US 2005/0147050 A1
(43) Pub. Date: Jul. 7, 2005

(54) Method for examining the connectivity of links in mpls networks

(76) Inventor: Joachim Klink, Muenchen (DE)

Correspondence Address: Siemens Corporation;Intellectual Property Department, 170 Wood Avenue South, Iselin, NJ, 08830, US

(21) Appl. No.: 10/513,055

(22) PCT Filed: Apr. 24, 2003
(86) PCT No.: PCT/DE03/01338

(30) Foreign Application Priority Data
Apr. 29, 2002 (DE) 102191530

(51) Int. Cl. H04L 1/00

(52) U.S. Cl. 370/244; 370/253

(57) ABSTRACT

The aim of the invention is to carry out an examination of the connectivity of MPLS-links in MPLS-networks. Specially formed MPLS-OAM packets are introduced into the traffic flow of user data packets and are supplied to other communication devices along the link. Each respective OAM-ECHO packet is copied, intermediately stored and re-routed in said communication device. The copied and intermediately stored packet is then retransmitted in the reverse direction, in the direction of the source where all in-coming copies are registered until the OAM-ECHO-packet is either extracted in the OAM-sink or if a pre-determined time span has been exceeded. Using the received and/or non-received copied of said packets, it is possible to determine if the connectivity of the connections is guaranteed.

### CROSS REFERENCE TO RELATED APPLICATIONS

This application is the US National Stage of International Application No. PCT/DE03/01338, filed Apr. 24, 2003 and claims the benefit thereof. The International Application claims the benefits of German application No. 10219153.0 filed Apr. 29, 2002, both of the applications are incorporated by reference herein in their entirety.

### FIELD OF INVENTION

The invention relates to a method for examining the connectivity of links in MPLS networks.

### BACKGROUND OF INVENTION

At the present state of the art, the OAM (Operation and Maintenance) functionality is to be regarded as an essential part of the operation of public communication networks. It supports the quality of the network performance while at the same time reducing the operating costs of the network. Particularly with regard to the quality of service (QoS) of the transmitted information it makes an essential contribution. Strategies with regard to the OAM functionalities have already been proposed for SONET/SDH and also for ATM networks.

### SUMMARY OF INVENTION

By means of the OAM functionality, the operator can obtain information about a communication network at any time with regard to whether a guaranteed quality of service (Service Level Agreement) can also be maintained for a link. For this purpose, the operator must also know the availability of existing links (“up” or “down” link), such as the time delay when transmitting information (delay, delay variation), and, if necessary averaged, deviation from the otherwise normal spacing between two information transmissions (delay jitter), or the number of items of information not even permitted to be transmitted (blocking rate, error performance).

If for example a connection fails, the fault must be immediately determined (fault detection), localized (fault location) and it must be possible to divert the link to a substitute route (protection switching) if necessary. In this way, the traffic flow in the network and the billing procedures can be improved.

MPLS networks are presently proposed for the transmission of information in the Internet. In MPLS (Multi Protocol Packet Label Switching) networks information is transmitted by means of MPLS packets. MPLS packets have a variable length and in each case have a header and information part. The header part is used to contain connection information and the information part to contain useful information. IP packets are used as useful information. The connection information contained in the header part is formed as an MPLS connection number. However, this is valid only in the MPLS network. Therefore if an IP packet from an Internet network enters the MPLS network (FIG. 1) the header part valid in the MPLS network is prefixed to it. This contains all the connection information that gives the path of the MPLS packet in the MPLS network. If the MPLS packet leaves the MPLS network, the header part is again removed and the IP packet is rerouted in the connected Internet network in accordance with the IP protocol. MPLS packets are transmitted unidirectionally.

In FIG. 1 it is, for example, assumed that information is sent from one user TLN1 to a user TLN2. The sending user TLN1 is in this case connected to the Internet network IP through which the information is passed in accordance with an Internet protocol such as the IP protocol. This protocol is not a link-oriented protocol. The Internet network IP has a number of routers R that can be interlinked with each other. The receiving user TNL2 is connected to a further Internet network IP. An MPLS network through which the information can be switched, link-oriented in the form of MPLS packets, is inserted between the two Internet networks IP. This network also has a number of routers interlinked with each other. In an MPLS network, these can be what are called label switched routers (LSR).

In MPLS networks the guarantee of quality (Quality of Service, QoS) is of leading importance. For this, knowledge of the connectivity of MPLS connections plays an important role for the network operator. He can provide appropriate connections for the user according to this information. In particular before putting an MPLS network into service, the complete network can be checked and checked through. However, the present state of the art makes no contribution to solving this problem.

The object of the invention is to provide a method by means of which information on the connectivity of connections in MPLS networks can be provided at low cost.

The object is achieved by the claims.

An advantage of the invention in particular is the provision of specially formed MPLS-OAM packets that are inserted into the traffic flow of useful data packets. To do this, it is necessary, in addition to the marking in the packet header as an MPLS-OAM packet (in order to distinguish the MPLS-OAM packets from MPLS packets carrying useful data), to have a further label. Packets defined in this way (designated in the following as OAM-ECHO packets) are used for monitoring the connectivity of an MPLS connection, in that each of these packets is inserted into the traffic flow, where it is fed to other communication devices along the link. In the communication devices, the OAM-ECHO packet is then copied, buffered and then transmitted back in the opposite direction in the direction of the source, where all incoming copies can be registered until the OAM-ECHO packet is either extracted in the OAM sink or the connection is discontinued at some point. Using the received and/or non-received
copies of said packets, it is possible to determine if the connectivity of the connection (LSP) is guaranteed.

Advantage further embodiments of the invention are given in the dependent claims.

The invention is explained in more detail in the following with the aid of the example of an embodiment.

These are as follows.

### BRIEF DESCRIPTION OF THE DRAWINGS

FIG. 1 The basic relationships in an MPLS network.

FIG. 2 An end-to-end connection between two users

FIG. 3 The relationships in the packet header and in the information part of an MPLS-OAM packet.

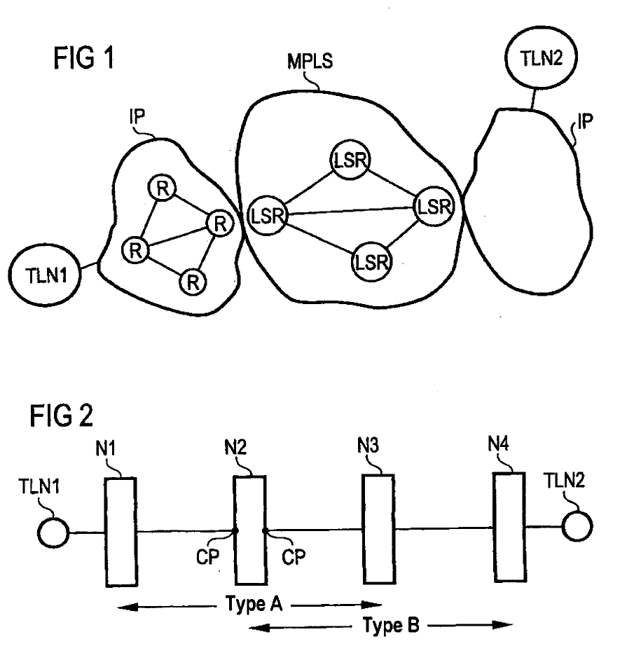

### DETAILED DESCRIPTION OF INVENTION

FIG. 2 shows a connection (Label Switched Path, LSP) between two users TLN1, TLN2. This connection is routed via a plurality of nodes N1 . . . N4, whereby a plurality of connection segments (Label Switched Hops) are defined. The nodes N1 . . . N4 should be formed as routers LSR of an MPLS network. After a connection has been successfully established, a flow of information now takes place between user TLN1 and user TLN2, which is formed of a plurality of the MPLS packets carrying useful data. MPLS-OAM packets can be inserted into this MPLS packet flow (inband LSP). In contrast to this, connections are defined via which only MPLS-OAM packets are routed (outband LSP). In principle, inband MPLS-OAM packets are useful to also log connections LSP on an individual basis. In some cases, however, it can be advantageous to define an out-of-band MPLS-OAM packet flow. An example of this is the MPLS group substitute switching.

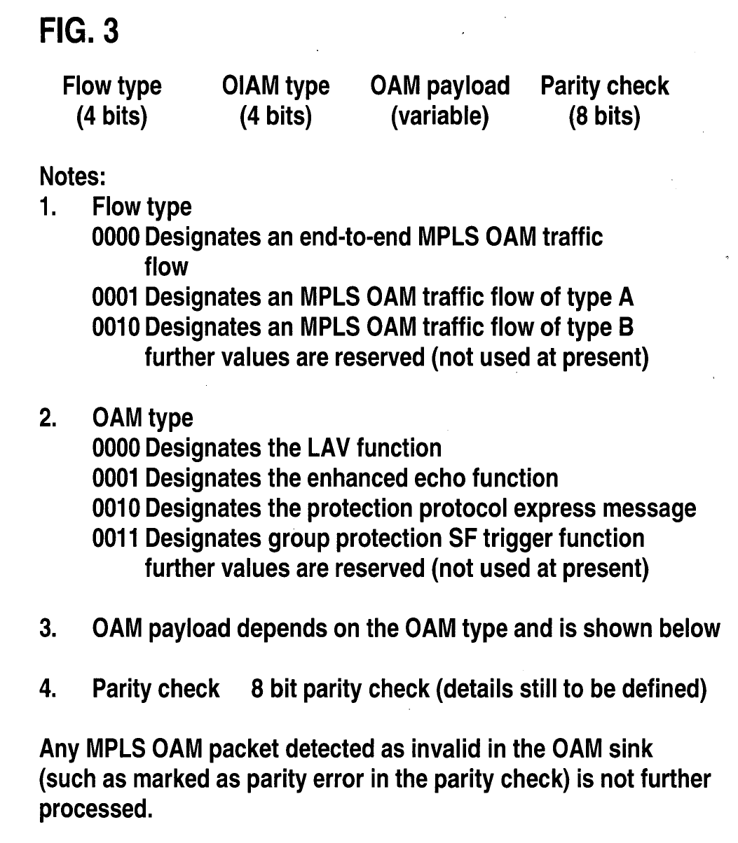

To be able to distinguish between MPLS-OAM packets and MPLS packets carrying useful data, the MPLS-OAM packets are marked. The special marking mechanisms are shown in FIG. 3 and are described below in more detail. The sequence of several MPLS-OAM packets defines an MPLS-OAM packet flow. Basically, three different types of MPLS-OAM packet flows exist simultaneously for a connection LSP.

End-to-end MPLS-OAM packet flow. This is used particularly for OAM communication between a source and a sink of a connection LSP. It is formed from MPSL-OAM packets that are inserted into the user data flow at the source of the connection LSP and can be extracted again therefrom at the sink. The MPLS-OAM packets can be recorded and monitored along the connection LSP to the connection point CP, without intervention into the transmission process (passive monitoring).

Type A MPLS-OAM packet flow is distinguished from the end-to-end defined MPLS-OAM packet flow. It is used particularly when an OAM communication takes place between the nodes that border a type A connection segment (FIG. 2). One or more type A MPLS-OAM segments can be defined in the connection LSP. However, they can be neither nested nor overlap with other type A segments.

Type B MPLS-OAM packet flow is distinguished from both aforementioned types of packet flow. It is used particularly when an OAM communication takes place between the nodes thiat border a type B connection segment (FIG. 2). One or more type B MPLS-OAM segments can be defined in the connection LSP. However, they can be neither nested nor overlap with other type B segments.

Basically, an MPLS-OAM packet flow (end-to-end, type A, type B) is formed from MPLS-OAM packets that are inserted into the useful data flow at the start of a segment and can be removed from this again at the end of the segment. They can be recorded and edited along the connection LSP, at the connection points CP, without intervention into the transmission process. Each connection point CP in the connection LSP, including the sources and sinks of the connection, can be configured as an MPLS-OAM source or MPLS-OAM sink, whereby the outgoing MPLS-OAM packets from an MPLS-OAM source are preferably configured as “upstream”.

Before MPLS-OAM packets (end-to-end, type A, type B) can be transmitted via the MPLS network, the end points (source, sink) of the associated MPLS-OAM segment must be defined. The definition of source and sink for an MPLS-OAM segment is not necessarily permanently specified for the duration of the connection. This means that the relevant segment can be reconfigured, for example by fields in the signaling protocol.

Nesting of the segmented MPLS-OAM packet flow (type A or type B) is possible for each connection LSP within an end-to-end MPLS-OAM packet flow. The connection points CP in this case can simultaneously be the source source/sink of a segment flow (type A or type B) and also of the end-to-end MPLS-OAM packet flow.

The MPLS-OAM packet flow (segment flow) of type A is functionally independent of that of type B with regard to insertion, extraction or processing of MPLS-OAM packets. Generally, nesting of MPLS-OAM packets of type B with those of type A, and vice versa, is possible. In event of nesting, a connection point CP can therefore be a source and sink of either an OAM segment flow of type A or type B simultaneously.

The overlapping of type A segments with type B segments is possible depending on the network architecture. For example, in the event of a point-to-point architecture segments of type A can be overlapped with those of type B. Both segments can operate independently of each other and therefore do not influence each other in any way. In MPLS substitute switching the overlapping can of course lead to problems.

The distinction between MPLS-OAM packets and MPLS packets carrying useful data can be achieved by using one of the EXP bits in the MPLS packet header. This procedure in particular makes distinguishing very simple. This bit can be checked in the sink of an MPLS-OAM segment or at the connection points CP to filter out MPLS-OAM packets before further assessments are undertaken.

Alternatively, one of the MPLS connection numbers (MPLS label values) No. 4 to No. 15 in the header of the MPLS packet can be used as a label. These MPLS connection numbers were reserved by the IANA. In this case, the next label in the stack must indicate the assigned connection LSP, for which the inband OAM functionality is performed. This approach to a solution is more complex to implement because the hardware in the OAM sink and the connection points CP requires two MPLS stack inputs for each MPLS-OAM packet. The processing must, of course, take place in real time, i.e. the OAM packets must again be inserted into the flow at the connection points CP whilst maintaining the sequence. This is absolutely necessary in order to ensure correct performance monitoring results in the OAM sink.

For monitoring (verification) of the connectivity of an MPLS connection LSP, special MPLS-OAM packets, referred to in the following as OAM-ECHO packets, are defined. For this purpose, the MPLS-OAM packets are provided with a special label (see FIG. 3). The OAM-ECHO packets formed in this way are inserted into the flow of useful information.

A characteristic of the echo function is that a single OAM-ECHO packet sent in the source (downstream) sends back a plurality of packets as an answer, and in fact a packet for each connection point CP in a node through which the assigned connection LSP is routed. This continues until the OAM-ECHO packet is extracted in the sink, i.e. is removed from the flow of useful information, or the connectivity of the assigned connection is interrupted at some point.

The echo function can be operated on an end-to-end basis or segment basis. In the case of the segment basis it is necessary to first define the limits of the MPLS-OAM segment for the assigned connection LSP. This is achieved in that the source and sink are configured first.

The echo function is a very useful means of checking where there is a requirement for connectivity of a connection LSP in an MPLS network. For example, the complete network can be checked for connectivity before an MPLS network is brought into service, or special connections can be checked through in the event of a complaint by a customer.

The echo function can be activated if required by an operator command for a specific connection LSP (end-to-end or segment basis) in each connection point CP. When operated on a segment basis the corresponding connection point CP must lie within the assigned OAM segment.

As a result of the activation, an OAM-ECHO packet sent in the source (downstream) is inserted into the traffic flow. At the same time a counter (e.g. a five-second counter) in the transmitting connection point (source) is started. Each further connection point connected to the sink (downstream) forwards the OAM-ECHO packet further in the direction of the sink and at the same time generates a copy of it. The OAM-ECHO packet is finally extracted from the OAM traffic flow in the sink (i.e. in the sink of the segment or end-to-end). The copies generated at the connection points are now further processed as follows:

First, the bit in the information part of the packet that designates the direction of transmission is changed from “downstream” to “upstream”. A location identifier is also entered in the information part of the OAM-ECHO packet. This is representative of the nodes (node ID) of the MPLS node where the processing was carried out. The location identifier also gives the assigned connection point (ingress or egress) (optional). The subsequent further processing of the packet now depends on whether a bidirectional or unidirectional mode is to be used.

In the case of a unidirectional mode, no feedback channel is necessary and the copied packet is stored in the MPLS node. The packets are then collected from all the MPLS nodes via signaling protocols and sent back to the source.

In the case of a bidirectional mode, a feedback channel for the assigned connection LSP is necessary to send back the copied OAM-ECHO packet to the source (upstream) where it was originally inserted (some MPLS protection switching configurations (e.g. bidirectional configuration and 1:1 architectures) use a feedback channel of this kind). The same procedure can also be used in the case of the echo function.

In fact a feedback in MPLS networks is basically not possible because the connections LSP are defined as unidirectional in this case. Thus, an additional functionality must be defined here to achieve the effect of feedback. In this case it is desirable for this additional functionality to be easy to handle and have little influence on the hardware equipment.

The feedback channel is achieved in that two unidirectional connections LSP are logically combined to form a bidirectional totality. What is essential in this case is for both connections LSP to follow the same physical path, but in the opposite direction in each case. In this case the same network elements are passed through by both connections LSP. This procedure can be achieved in that LDP signaling methods (Label Distribution Protocol) are used with explicit routing, in that the same explicit route is defined in advance for both connections LSP in the forwards and backwards direction.

Assuming that a feedback signal (as described above) is now available, the copied OAM-ECHO packets are transmitted in each connection point along the feedback channel without modification (upstream) until they are extracted at the sink of the feedback channel (source of the OAM-ECHO packet). Here (i.e. in the connection point where the OAM-ECHO packet was originally inserted into the traffic flow (downstream)) the following actions take place.

For the duration if the five-second counter, all OAM-ECHO packets downstream of this connection point on the assigned connection LSP of the feedback channel are sent to further network devices. They are additionally copied and stored in the associated MPLS node.

The MPLS node that originally transmitted an OAM-ECHO packet in the downstream direction now receives an answer in the form of an upstream OAM-ECHO packet from each MPLS node (and each connection point) until the packet has either been extracted in the OAM sink or the five-second counter has elapsed. In the latter case, the connection is defined as interrupted.

1-10. (canceled)

11. A method for connection-oriented transmission of packets of variable length via a connection formed by a plurality of connection segments, the method comprising:
marking some of the packets with a marking;
marking the marked packets with a label at a send-site of a source;
inserting the labeled packets into a traffic flow at the source, wherein each labeled packet is copied, buffered and forwarded by each communication device along the connection;
transmitting the copies of the labeled packet in a direction to the source, wherein all incoming copies are registered at the source until the labeled packet has either been extracted at a sink or a predetermined time period has elapsed.

12. The method in accordance with claim 11, wherein
the packets of variable length are transmitted in accordance with a multi protocol label switching transmission method (MPLS), wherein
the packets are MPLS packets,
the marked packets are MPLS-OAM packets,
the labeled packets are OAM-ECHO packets for checking a connectivity of a MPLS network.

13. The method in accordance with claim 12, wherein the OAM-ECHO packets form a segmented MPLS-OAM traffic flow that is transmitted within a segment of the connection, designated as an OAM segment, wherein the OAM segment is monitored for connectivity.

14. The method in accordance with claim 12, wherein the OAM-ECHO packets are inserted into the traffic flow at any communication device along the connection, wherein checking the connectivity using the copies of the OAM-ECHO packets arriving at the respective communication device in the direction to the source takes place in the respective communication device.

15. The method in accordance with claim 13, wherein the OAM-ECHO packets are inserted into the traffic flow at any communication device along the connection, wherein checking the connectivity using the copies of the OAM-ECHO packets arriving at the respective communication device in the direction to the source takes place in the respective communication device.

16. The method in accordance with claim 12, wherein
the OAM-ECHO packet contains a further label indicating a transmission direction of the OAM-ECHO packet, and wherein
the copies of the OAM-ECHO packet generated in each communication device are transmitted in the direction to the source after the further label has been changed.

17. The method in accordance with claim 13, wherein
the OAM-ECHO packet contains a further label indicating a transmission direction of the OAM-ECHO packet, and wherein
the copies of the OAM-ECHO packet generated in each communication device are transmitted in the direction to the source after the further label has been changed.

18. The method in accordance with claim 14, wherein
the OAM-ECHO packet contains a further label indicating a transmission direction of the OAM-ECHO packet, and wherein
the copies of the OAM-ECHO packet generated in each communication device are transmitted in the direction to the source after the further label has been changed.

19. The method in accordance with claim 15, wherein a transmission direction included in each OAM-ECHO packet is checked to ensure that only OAM-ECHO packets containing a transmission direction in the direction to the source are used for checking the connectivity.

20. The method in accordance with claim 16, wherein a transmission direction included in each OAM-ECHO packet is checked to ensure that only OAM-ECHO packets containing a transmission direction in the direction to the source are used for checking the connectivity.

21. The method in accordance with claim 12, wherein the OAM-ECHO packets are forwarded, copied and buffered in each communication device along the connection before and after a MPLS connection matrix of the MPSL network.

22. The method in accordance with claim 13, wherein the OAM-ECHO packets are forwarded, copied and buffered in each communication device along the connection before and after a MPLS connection matrix of the MPSL network.

23. The method in accordance with claim 14, wherein the OAM-ECHO packets are forwarded, copied and buffered in each communication device along the connection before and after a MPLS connection matrix of the MPSL network.

24. The method in accordance with claim 16, wherein the OAM-ECHO packets are forwarded, copied and buffered in each communication device along the connection before and after a MPLS connection matrix of the MPSL network.

25. The method in accordance with claim 19, wherein the OAM-ECHO packets are forwarded, copied and buffered in each communication device along the connection before and after a MPLS connection matrix of the MPSL network.

26. The method in accordance with claim 12, wherein, for the copies of an OAM-ECHO packet buffered in each communication device along the connection information representing a local designation of the respective communication device is stored for enabling unambiguous locating of the respective communication device.

27. The method in accordance with claim 13, wherein, for the copies of an OAM-ECHO packet buffered in each communication device along the connection information representing a local designation of the respective communication device is stored for enabling unambiguous locating of the respective communication device.

28. The method in accordance with claim 12, wherein
the copies of an OAM-ECHO packet buffered in each communication device along the connection are sent back to the source using a MPLS signaling protocol.

29. The method in accordance with claim 13, wherein
the copies of an OAM-ECHO packet buffered in each communication device along the connection are sent back to the source using a MPLS signaling protocol.

30. The method in accordance with claim 12, wherein
copies of an OAM-ECHO packet buffered in each communication device along the connection are sent back to the source, wherein
the copies of the OAM-ECHO packet are transmitted via a further connection associated with the connection, wherein
the connections have opposite transmitting directions and are operatively connected to the same communication devices.
